(19) United States
(12) Patent Application Publication
(10) Pub. No.: US 2009/0272215 A1
(43) Pub. Date: Nov. 5, 2009

(54) Pivotable heel shifter for a motorcycle

(76) Inventor: Thomas Plackis, Hendersonville, NC (US)

Correspondence Address: Thomas M. Galgano, 20 W. Park Avenue, Suite 204, Long Beach, NY, 11561, US

(21) Appl. No.: 12/151,065

(22) Filed: May 2, 2008

(51) Int. Cl. B62M 25/06; G05G 9/00; B62J 25/00

(52) U.S. Cl. 74/473.16; 74/512; 280/291

(57) ABSTRACT

A heel shifter for a motorcycle has a pivotable pedal so that the pedal may be pivoted up out of the way to give more room for the rider's foot on the left floor board.

### BACKGROUND OF THE INVENTION

1. Field of the Invention

This invention relates broadly to motorcycles. More particularly, this invention relates to motorcycle shift pedals. Most particularly, the invention relates to a heel shifter having a pivotable pedal.

2. State of the Art

State of the art large motorcycles (i.e. touring motorcycles such as that shown in prior art FIG. 1) have left and right floor boards, e.g. left floor board 1. Once the rider reaches highway speed, he or she may comfortably keep both feet on the floor boards, rather than on pegs which are used on smaller motorcycles.

Conventional motorcycle shifting is performed with the rider's left foot operating a toe and heel shift lever 2. The typical shifter on a large motorcycle is made from two separate arms 3, 4 attached to a single common shifting shaft 5. However, some toe and heel shifters are made with arms 3, 4 being integrally formed with a central bend about the portion of the arm which attaches to the shifting shaft 5. FIG. 2 shows a toe and heel shifter where the arms 3, 4 are integrally formed. The front arm 3 has a toe pedal 6 extending perpendicular from the arm and parallel to the floor board 1. The rear arm 4 has a heel pedal 7 extending perpendicular from the arm and parallel to the floor board 1. The standard motorcycle shift pattern (with toe and heel shifters and on motorcycles having only a toe shifter) is to press the toe pedal down in the direction marked by the arrow A in FIG. 2 to enter first gear. The remaining sequential gears (typically 2 through 5) are entered by lifting the toe pedal up in the direction shown by the arrow B in FIG. 2. It will be appreciated that in lieu of lifting the toe pedal up, one can press down on the heel pedal in the direction shown by the arrow C in FIG. 2. Using the heel pedal 7 to upshift from first gear has several advantages over lifting the toe pedal 6. One advantage is that there is less wear/scuffing on the tip of the rider's boot which must get under the toe pedal to lift it. In addition, many riders find pushing the heel down more natural and less awkward than lifting the toe up. Moreover, in the case of integrally formed toe and heel shifters, where the height of the toe pedal 6 is not independently adjustable relative to the height of the heel pedal 7, some riders with large boots may find it difficult or impossible to get their toe under the toe pedal 6 to lift it.

### SUMMARY OF THE INVENTION

The present invention provides a heel shifter having an arm and a heel pedal where the heel pedal is pivotable relative to the arm. The invention provides several advantages. First, after using the heel pedal to enter top gear, the heel pedal can be moved up 90 degrees and away from the floor board. This provides a more comfortable riding position than conventional heel shifters, particularly for riders with large feet. The presently preferred embodiment is designed for motorcycles having separate toe and heel shifters coupled to a common shifting shaft. In this manner, the rider only needs to replace the heel shifter and can keep using the original toe shifter. Alternatively, the invention can be made part of a unitary toe and heel shifter. In either case, structure is provided to limit the angle through which the heel pedal can be pivoted. Preferably, the structure prevents the pedal from pivoting below being parallel to the floor board and prevents it from being rotated upward to a position where it would interfere with movement of the toe pedal (e.g. when downshifting). The invention may also be applied to the toe pedal in a touring motorcycle to provide even more comfort space for the rider's left foot. However, it is preferred that the toe pedal not be pivotable as it may be needed for emergency downshifting.

Certain of the foregoing and related objects are attained according to the present invention by the provision of a heel shifter for a motorcycle, comprising an arm having a first end and a second end defining a longitudinal axis extending therebetween, said first end defining a shaft receiving bore substantially orthogonal to said longitudinal axis for receiving the shifting shaft of a motorcycle transmission, said second end defining a cut-out substantially orthogonal to said longitudinal axis and a first axle receiving bore substantially collinear with said longitudinal axis, a pedal having a generally rectangular narrowed portion defining a second axle receiving bore, said narrowed portion residing in said cutout with said second axle receiving bore substantially collinear with said first axle receiving bore, and a pivot axle extending through said first axle receiving bore and said second axle receiving bore, said pivot axle, said pedal, and said second end of said arm thereby defining a three knuckle hinge.

Preferably, said cut-out defines two walls disposed at a substantially ninety degree angle relative to each other, said walls limiting movement of said pedal to a substantially ninety degree range. Advantageously, the heel shifter further comprises a set screw, wherein said first end further defines a set screw receiving bore with said set screw disposed therein.

In a preferred embodiment according to the invention, a heel shifter for a motorcycle having a floor board and a transmission having a transmission shifting shaft located above the floor board is provided comprising an arm having a first end and a second end, said first end having means for mounting on the shifting shaft, a shifting pedal pivotally coupled to said second end of said arm and being movable from a first position wherein said pedal is substantially parallel to the floor board and may be used to upshift the transmission to a second position wherein said pedal is substantially perpendicular to the floor board thereby providing more room for the rider's foot on the floor board.

In a particularly, preferred embodiment, a combined toe and heel shifter for a motorcycle having a floor board and a transmission having a transmission shifting shaft located above the floor board is provided comprising integral forward and rearward extending arms defining a centrally located mounting hub for coupling to the shifting shaft, a toe shifting pedal coupled to said forward extending arm, a heel shifting pedal pivotally coupled to said second end of said arm and being movable from a first position wherein said heel shifting pedal is substantially parallel to the floor board and may be used to upshift the transmission to a second position wherein said heel shifting pedal is substantially perpendicular to the floor board thereby providing more room for the rider's foot on the floor board.

In yet a further embodiment of the invention, a motorcycle is provided comprising a floor board, a transmission having a shifting shaft located above said floor board, an arm having a first end and a second end, said first end being coupled to said shifting shaft, a shifting pedal pivotally coupled to said second end of said arm and being movable from a first position wherein said pedal is substantially parallel to the floor board and may be used to upshift the transmission to a second position wherein said pedal is substantially perpendicular to the floor board thereby providing more room for the rider's foot on the floorboard.

Additional objects and advantages of the invention will become apparent to those skilled in the art upon reference to the detailed description taken in conjunction with the provided figures.

### BRIEF DESCRIPTION OF THE DRAWINGS

FIG. 1 is a side elevation view of a prior art touring motorcycle showing the left floor board and the toe and heel shifter;

FIG. 2 is an enlarged side elevation view of the prior art left floor board and integrally formed toe and heel shifter;

FIG. 3 is a broken perspective view of a touring motorcycle left floor board, independent toe shifter and a heel shifter according to the invention shown with the pedal pivoted down in the operational position;

FIG. 4 is a view similar to FIG. 3 showing the heel pedal pivoted up;

FIG. 5 is an enlarged broken perspective view of a touring motorcycle left floor board, independent toe shifter and a heel shifter according to the invention shown with the pedal pivoted down in the operational position;

FIG. 6 is a view similar to FIG. 5 showing the heel pedal pivoted up;

FIG. 7 is a side elevation of a touring motorcycle left floor board and an integrally formed toe and heel shifter according to the invention shown with the heel pedal pivoted up; and

FIG. 8 is a view similar to FIG. 7 but with the heel shifter pedal pivoted down to the operational position.

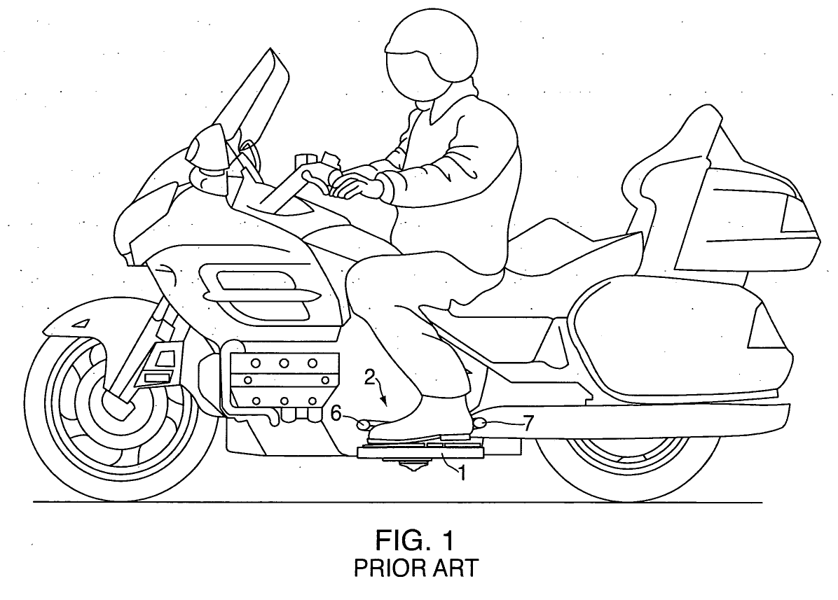

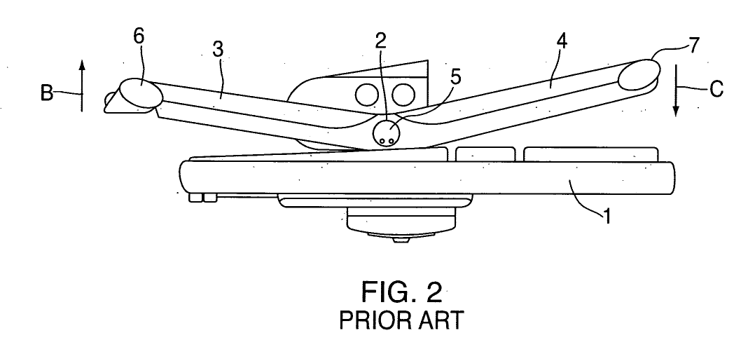

### DETAILED DESCRIPTION

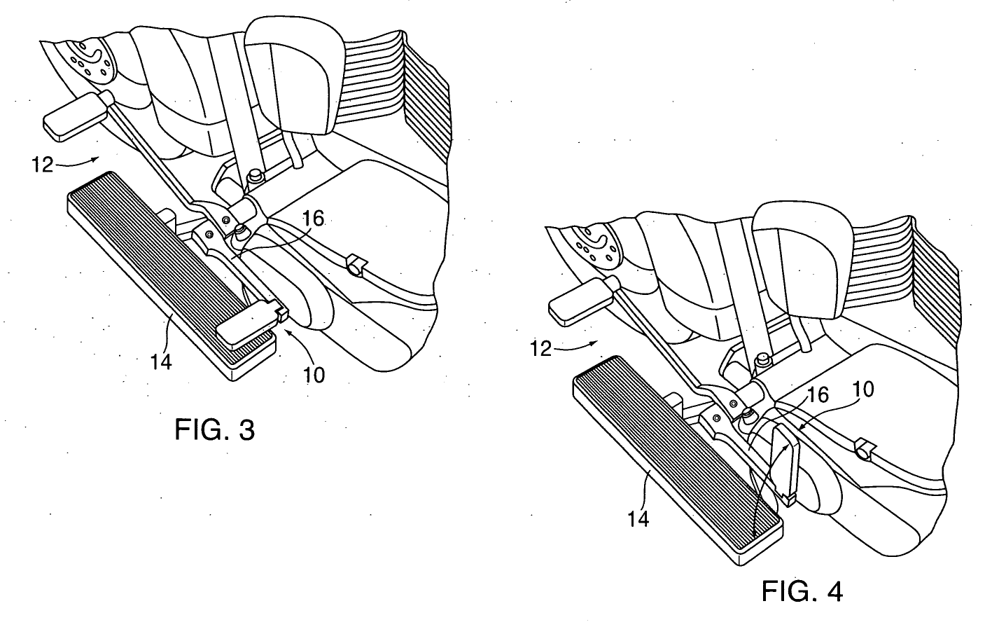

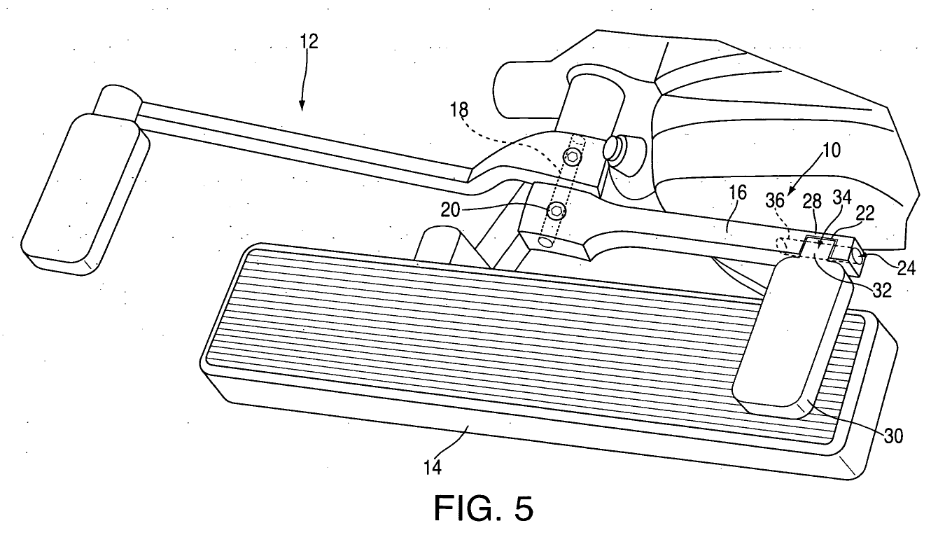

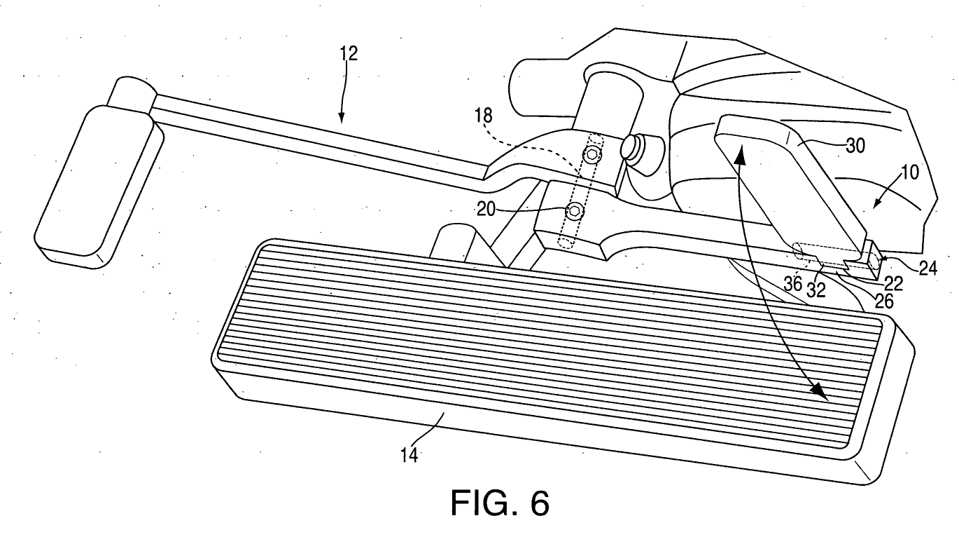

Turning now to FIGS. 3 through 6, an independent heel shifter 10, according to the invention, is shown together with an independent toe shifter 12 and a floor board 14. The heel shifter 10 includes an arm 16 having first and second ends. The first end has a shaft receiving bore 18 (seen best in FIGS. 5 and 6) with a radially arranged bore and set screw 20. The shaft receiving bore 18 is shown mounted on a motorcycle transmission shifting shaft and held in place by the set screw 20.

The second end of the arm 16 has a substantially ninety degree cut-out 22 and a pivot axle receiving bore 24. The cut-out 22 is substantially orthogonal to the longitudinal axis of the arm 16 and the bore 24 is substantially collinear with the longitudinal axis of the arm. The cut-out 22 preferably defines a lower horizontal wall 26 (seen best in FIG. 6) and an inner vertical wall 28 (seen best in FIG. 5).

A generally rectangular heel pedal 30 is provided with a narrowed end portion 32. The end portion 32 is dimensioned to be received by the cut-out 22 and is provided with a pivot axle receiving bore 34. As assembled, the narrowed portion 32 is inserted into the cut-out 22 and a pivot axle 36 is inserted into the bores 24 and 34, thereby forming a three knuckle hinge.

From the foregoing, those skilled in the art will appreciated that the assembled arm 16, pedal 30 and axle 36 allow the pedal 30 to pivot from the horizontal position shown in FIGS. 3 and 5 to the vertical position shown in FIGS. 4 and 6. In the horizontal position, gravity is sufficient to keep the pedal properly oriented. The pedal 30 is secured in the vertical position by friction fit or by providing locking detents (not shown). The walls 26 and 28 limit the pivoting movement of the pedal 30.

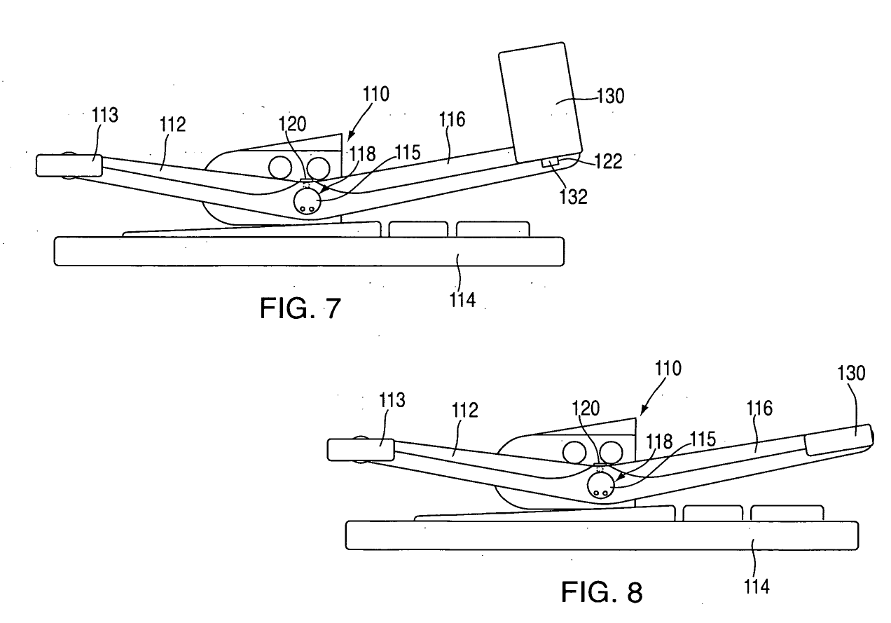

The embodiment shown in FIGS. 3-6 is designed to be fitted onto a motorcycle which has independent toe and heel shifters both of which are coupled to the same transmission shifting shaft. However, the invention may be applied to an integrally formed toe and heel shifter as illustrated in FIGS. 7 and 8.

Turning now to FIGS. 7 and 8, an integrally formed toe and heel shifter 110 according to the invention includes a toe shifter arm 112 and a heel shifter arm 116 which are formed as an integral unit. The shifter 110 is shown in conjunction with a floor board 114 and a transmission shifting shaft 115. The end of the arm 112 is provided with a toe pedal 113. The end of the arm 116 is provided with a pivoting heel pedal 130 which has a narrowed portion 132 which fits into a cut-out 122 and is mounted on a pivot axle as described above with reference to FIGS. 3-6. The integrally formed arms 112, 116 are provided with a generally centrally located shaft receiving bore 118 and a set screw 120 for mounting the shifter on a transmission shifting shaft 115.

Both embodiments of the invention allow riders with large feet to ride more comfortably after reaching top gear without giving up the functionality of a heel shifter.

There have been described and illustrated herein several embodiments of a pivotable heel shifter for a motorcycle. While particular embodiments of the invention have been described, it is not intended that the invention be limited thereto, as it is intended that the invention be as broad in scope as the art will allow and that the specification be read likewise. Where the word substantially has been used with regard to angular relationships, it is intended to mean that the angle has a tolerance and need not be exact; it is sufficient that the angle be close enough to achieve the desired functionality. It will therefore be appreciated by those skilled in the art that yet other modifications could be made to the provided invention without deviating from its spirit and scope as claimed.

What is claimed is:

1. A heel shifter for a motorcycle, comprising:
an arm having a first end and a second end defining a longitudinal axis extending therebetween,
said first end defining a shaft receiving bore substantially orthogonal to said longitudinal axis for receiving the shifting shaft of a motorcycle transmission,
said second end defining a cut-out substantially orthogonal to said longitudinal axis and a first axle receiving bore substantially collinear with said longitudinal axis,
a pedal having a generally rectangular narrowed portion defining a second axle receiving bore, said narrowed portion residing in said cutout with said second axle receiving bore substantially collinear with said first axle receiving bore, and
a pivot axle extending through said first axle receiving bore and said second axle receiving bore,
said pivot axle, said pedal, and said second end of said arm thereby defining a three knuckle hinge.

2. A heel shifter according to claim 1, wherein:
said cut-out defines two walls disposed at a substantially ninety degree angle relative to each other, said walls limiting movement of said pedal to a substantially ninety degree range.

3. A heel shifter according to claim 1, further comprising:
a set screw, wherein
said first end further defines a set screw receiving bore with said set screw disposed therein.

4. A heel shifter for a motorcycle having a floor board and a transmission having a transmission shifting shaft located above the floor board, comprising:
an arm having a first end and a second end, said first end having means for mounting on the shifting shaft,
a shifting pedal pivotally coupled to said second end of said arm and being movable from a
first position wherein said pedal is substantially parallel to the floor board and may be used to upshift the transmission to a
second position wherein said pedal is substantially perpendicular to the floor board thereby providing more room for the rider's foot on the floor board.

5. A combined toe and heel shifter for a motorcycle having a floor board and a transmission having a transmission shifting shaft located above the floor board, comprising:
integral forward and rearward extending arms defining a centrally located mounting hub for coupling to the shifting shaft,
a toe shifting pedal coupled to said forward extending arm,
a heel shifting pedal pivotally coupled to said second end of said arm and being movable from a
first position wherein said heel shifting pedal is substantially parallel to the floor board and may be used to upshift the transmission to a
second position wherein said heel shifting pedal is substantially perpendicular to the floor board thereby providing more room for the rider's foot on the floor board.

6. A motorcycle, comprising:
a floor board,
a transmission having a shifting shaft located above said floor board,
an arm having a first end and a second end, said first end being coupled to said shifting shaft,
a shifting pedal pivotally coupled to said second end of said arm and being movable from a
first position wherein said pedal is substantially parallel to the floor board and may be used to upshift the transmission to a
second position wherein said pedal is substantially perpendicular to the floor board thereby providing more room for the rider's foot on the floorboard.
